(19) United States
(12) Patent Application Publication
(10) Pub. No.: US 2014/0042661 A1
(43) Pub. Date: Feb. 13, 2014

(54) METHOD OF FORMING A BATTERY SEPARATOR AND SECONDARY BATTERY

(71) Applicant: Nippon Kodoshi Corporation, Kochi (JP)

(72) Inventors: Takashi Sakuma, Kochi (JP); Masahiko Ueta, Kochi (JP); Kohei Nishizaka, Kochi (JP); Masatoshi Sashika, Kochi (JP); Yasuhisa Yamasaki, Kochi (JP)

(73) Assignee: Nippon Kodoshi Corporation, Kochi (JP)

(21) Appl. No.: 13/962,769

(22) Filed: Aug. 8, 2013

Related U.S. Application Data
(62) Division of application No. 13/050,115, filed on Mar. 17, 2011, now abandoned.

(30) Foreign Application Priority Data
Mar. 19, 2010 (JP) 2010064495

(51) Int. Cl. H01M 2/14; H01M 2/16

(52) U.S. Cl. CPC H01M 2/145; H01M 2/1666
USPC 264/103; 427/58; 427/538; 427/553

(57) ABSTRACT

A method of forming a battery separator to be sandwiched between a positive and a negative electrode of a battery is discussed. A polyethylene resin surface is formed on a surface of a nonwoven fabric, which is made of polypropylene resin as a main component material and structured with bonded pieces of the polypropylene resin. The polyethylene resin surface is then subjected to a hydrophilization treatment, such as a radical reaction treatment or a sulfonation treatment. As a result, a secondary battery separator having a high mechanical strength along with a high hydrophilic nature, and a secondary battery using that secondary battery separator are provided.

### CROSS REFERENCE TO RELATED APPLICATIONS

This application is a divisional application of U.S. patent application Ser. No. 13/050,115 filed on Mar. 17, 2011, currently pending, which claims priority to Japanese Patent Application No. 2010-064495 filed on Mar. 19, 2010. The disclosures of U.S. patent application Ser. No. 13/050,115 and Japanese Patent Application No. 2010-064495 are hereby incorporated by reference.

### BACKGROUND OF THE INVENTION

1. Field of the Invention

The present invention relates to a battery separator suitable for a secondary battery and a secondary battery. More specifically, for example, it relates to an optimal battery separator for an alkali secondary battery, and an alkali secondary battery.

2. Description of the Related Art

Alkali secondary batteries, such as nickel-hydrogen secondary batteries, are excellent in charging and discharging characteristics and over-charging and over-discharging characteristics, and have a long life and can be used repeatedly. Moreover, since they have a low internal resistance and are excellent in large current flow characteristics, use thereof as a battery for electric vehicles and power tools is expected.

The separator used for those batteries needs to have
(1) a hydrophilic nature and capability of retaining an electrolytic solution, and
(2) a sufficient mechanical strength to prevent a burr from developing at the time of manufacturing a battery and a short circuit from occurring between a positive and a negative electrode due to dendrite etc. developed during use of the battery.

Conventionally, polyamide nonwoven fabrics with a high hydrophilic nature have been used as this type of secondary battery separator. However, the following problems are found. That is, a separator made of one of the polyamide nonwoven fabrics will be gradually dissolved in an alkaline electrolytic solution, and the shuttle effect in which ammonia generated at the time of decomposition will be oxidized with nitrate ions on a positive electrode and then reduced to ammonia on a negative electrode may lead to an increased self-discharge rate (Battery Handbook (published in 2002), p. 237-238, edited by Yoshiharu Matsuda and Zenichiro Takehara.)

To solve these problems, a polyolefin nonwoven fabric having an excellent chemical stability has come to be used as a separator instead of the polyamide nonwoven fabric. However, since the polyolefin nonwoven fabric is inferior in hydrophilic nature to the polyamide nonwoven fabric, it is necessary to perform the following various hydrophilization treatments.

### (1) Surfactant Treatment

This treatment is a comparatively easy-to-use method of applying a surfactant to the separator. More specifically it may be a method of coating an acetylene glycol nonionic surfactant including an intramolecular polyalkylene oxide group described in JP 2000-164193 A, for example.

### (2) Corona Discharge Treatment, Plasma Treatment, and UV Ozonization

These treatments are all inexpensive disposal methods of introducing a hydrophilic group, such as a carboxyl group, onto a resin surface using radicals generated through each method. More specifically, through the corona discharge treatment, a material to be processed is irradiated with corona, which is generated through corona discharge caused by application of a high frequency high voltage pulse electric field described in JP 2001-043843 A, for example. On the other hand, in the plasma treatment, plasma discharge occurs by applying an electric field between a pair of electrodes opposing each other, as described in JP 2001-068087 A, for example, thereby making a material to be processed obtain a hydrophilic nature. Note that in the following description, these treatments are collectively referred to as “radical reaction treatment”.

### (3) Fluorine Gas Treatment

This treatment is a method of introducing a carboxyl group onto a fiber surface using the oxidation force of fluorine gas. More specifically, in the fluorine gas treatment, a mixed gas of fluorine and oxygen is applied to a nonwoven fabric, thereby introducing a carboxyl group onto the fiber surface.

### (4) Acrylic Acid Graft-Polymerization Treatment

This is a treatment for provision of a hydrophilic nature by carrying out graft polymerization of an acrylic acid with a fiber. It is understood that this treatment will not only provide a hydrophilic nature, but will also prevent self-discharge of a battery. This is because the separator adsorbs ammonia, which is a causative agent for the shuttle effect.

A specific example of such treatment is disclosed in JP H10-125300 A, in which graft polymerization of an acrylic acid is carried out by immersing a nonwoven fabric in a mixed solution consisting of water as a solvent, benzophenone as a polymerization initiator, and an acrylic acid as a vinyl monomer, and then applying ultraviolet rays from a mercury lamp in a nitrogen ambient atmosphere for several minutes.

### (5) Sulfonation Treatment

This is a method of introducing a sulfonic acid group into a fiber and thereby providing a hydrophilic nature. It is understood that, in addition to providing the hydrophilic nature, self-discharge of a battery may be suppressed in the same manner as the acrylic acid graft-polymerization treatment.

More specifically, such a treatment may be a sulfonation treatment of immersing in a mixed solution of sulfuric acid and fuming sulfuric acid (e.g., JP H08-236094 A), or a non-contact sulfonation treatment of putting a fiber on a sulfuric acid mixed solution of fuming sulfuric acid and concentrated sulfuric acid and then heating the sulfuric acid mixed solution and baking a sample etc. (e.g., JP H11-144698 A).

The sulfonation treatment has a side reaction that the separator carbonizes when a sulfonic acid group is introduced, and if the treatment is strengthened so as to improve the hydrophilic nature, the mechanical strength of the separator will decrease.

Meanwhile, the polyolefin nonwoven fabric subjected to the above-described hydrophilization treatment may be a wet-type nonwoven fabric made from a single fiber such as polypropylene or a sheath-core type bicomponent fiber made of polypropylene and polyethylene or a splittable conjugate fiber made of the same, or a dry-type nonwoven fabric, such as a spunbonded nonwoven fabric made of polypropylene or a melt blown nonwoven fabric made of the same.

Nowadays, of combinations of the above-described hydrophilization treatment and polyolefin nonwoven fabrics, a sulfonated, wet-type nonwoven fabric, which is made of a sheath-core type bicomponent fiber or a splittable conjugate fiber made of polypropylene and polyethylene, or a single fiber made of polypropylene etc, is often used to make a separator.

### SUMMARY OF THE INVENTION

The dry-type polypropylene nonwoven fabric may be manufactured through fewer steps than those for the wet-type nonwoven fabric, and thus is low in cost. Furthermore, the dry-type polypropylene nonwoven fabric is formed by connecting pieces of polypropylene, which is stronger than polyethylene. Therefore, it features better mechanical characteristics, such as tensile strength, puncture strength, tearing strength and the like, than those of the wet-type nonwoven fabric.

However, since polypropylene is inferior in reactivity to polyethylene, good results from the hydrophilization treatment, such as a radical reaction treatment or a sulfonation treatment, may not be expected, and it is inferior in hydrophilic nature to the wet-type nonwoven fabric.

The present invention is devised in light of the above-described problems, and aims to provide a battery separator and a battery using the same where, for example, hydrophilic nature of the dry-type polypropylene nonwoven fabric is improved and the higher hydrophilic nature thereof is compatible with the higher mechanical strength thereof.

As a method to solve the problems, forming, for example, a polyethylene layer with a high reactivity on the surface of a dry-type polypropylene nonwoven fabric, and then carrying out a hydrophilization treatment, such as a radical reaction treatment or a sulfonation treatment, is proposed.

That is, the present invention provides a battery separator used sandwiched between a positive and a negative electrode of a battery wherein the battery separator is characterized in that it is fabricated by forming a polyethylene resin surface on a surface of a nonwoven fabric made of polypropylene resin as a main component material and structured with bonded pieces of the polypropylene resin, and subjecting the polyethylene resin surface to a hydrophilization treatment.

Furthermore, in the present invention, the hydrophilization treatment is, for example, either a single treatment or multiple treatments selected from a radical reaction treatment and a sulfonation treatment. Yet even further, the hydrophilization treatment is carried out by carrying out the radical reaction treatment, for example, followed by the sulfonation treatment. Yet even further, the radical reaction treatment is a treatment selected from a corona discharge treatment, a plasma treatment, and a UV ozonization treatment, for example.

Yet even further, the present invention is characterized in that said forming the polyethylene resin surface on the surface of the nonwoven fabric is carried out by applying, for example, polyethylene emulsion to the surface of the nonwoven fabric. Yet even further, coating weight of the polyethylene emulsion is 0.1 to 10.0 wt % relative to the basic weight of the nonwoven fabric.

Furthermore, the present invention is characterized in that the nonwoven fabric is fabricated using the spunbond technology, for example.

Yet even further, the present invention provides a secondary battery characterized by using the battery separator according to any one of the above-described configurations. The secondary battery according to the present invention is characterized by being a nickel-hydrogen storage battery.

According to the present invention, a battery separator having a greater mechanical strength and an improved hydrophilic nature compatible therewith may be provided.

### BRIEF DESCRIPTION OF DRAWING

FIG. 1 is a flowchart describing a manufacturing process of a battery separator according to an embodiment of the present invention.

### DETAILED DESCRIPTION OF THE INVENTION

Hereafter, an embodiment according to an aspect of the present invention is described in detail. The embodiment is a battery separator used sandwiched between a positive electrode and a negative electrode, and is characterized in that the battery separator is fabricated by forming a polyethylene resin surface on a surface of a nonwoven fabric, which is made of polypropylene resin as a main component material and is structured with bonded pieces of the polypropylene resin, and subjecting the polyethylene resin surface to a hydrophilization treatment, such as a radical reaction treatment or a sulfonation treatment.

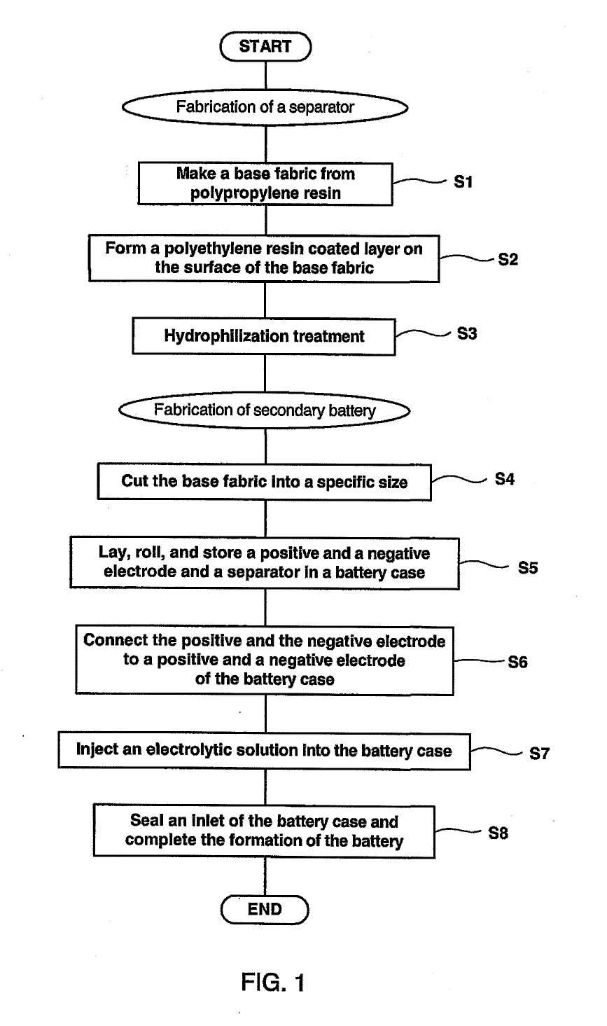

An outline of a separator manufacturing process according to the embodiment and a manufacturing process of a secondary battery using the separator is described below with reference to FIG. 1. FIG. 1 shows a process flow describing an outline of a manufacturing method for a battery separator and a secondary battery using the battery separator according to the embodiment of the present invention.

Steps S1 to S3 describe the outline of the manufacturing process for the battery separator according to the embodiment of the present invention, and steps S4 to S8 describe the outline of the manufacturing process for the secondary battery.

First, in step S1, a sheet is formed as a base fabric using an arbitrary method. Polypropylene resin is used as a main component material to make the base fabric, wherein most confounding points should be formed by bonding pieces of the polypropylene resin. More specifically, a spunbonded nonwoven fabric made of extended continuous fibers may be preferable so as to obtain good mechanical characteristics.

The form and size of the polypropylene resin as a raw material are not limited as long as its basic skeleton is made of polypropylene, and basic performance of the battery is not inhibited. However, configurations having functional groups including nitrogen, such as amine, and bonding thereof are not preferable because they may cause the shuttle effect like the above-described polyamide nonwoven fabric, resulting in a large amount of self-discharge.

In step S2, a polyethylene resin coated layer (hereafter, referred to as ‘PE coat’) is formed on the surface of the base fabric by applying a polyethylene resin emulsion, etc. The polyethylene resin may be of any type as long as it allows formation of a polyethylene resin layer on the surface of the base fabric made of polypropylene resin, and therefore any other material may be fully used as long as the basic skeleton is made of polyethylene, regardless of the other structures.

That is, the molecular structure of the polyethylene resin may include a functional group, such as an ester group or a phenyl group, or a double bond. However, when it includes a functional group including nitrogen, such as amine, or a bonded configuration thereof, it may cause the above-described shuttle effect, and therefore use thereof is not preferable.

Moreover, the disperse medium for polyethylene resin emulsion can be of any type as long as it is a solvent capable of scattering pieces of polyethylene resin. However, since those including nitrogen tend to promote the shuttle effect described earlier, use thereof is not preferable. It is preferable to use water in light of ready availability of a solvent, safety on handling it as a disperse medium and emulsion, and stability during storage.

Well-known methods, such as a method of immersing a base fabric in the polyethylene resin emulsion or a method of dipping and impregnating, may be used for application of a polyethylene resin emulsion. For example, spraying a polyethylene resin emulsion on a base fabric may be effective.

It is preferable that coating weight of the polyethylene resin on the base fabric made of polypropylene resin should be 0.1 to 10 wt % relative to the basic weight or paper weight of the base fabric. More preferably, the coating weight should be 1 to 5 wt %, and most preferably, it should be 3 wt %. When it is less than 0.1 wt %, a desired result can not be obtained, and when it exceeds 10 wt %, gaps between fibers comprising the base fabric are filled, thereby raising airtightness of the separator and consequently increasing the internal resistance too high when it is incorporated into a battery.

In step S3, the fiber surface of the nonwoven fabric is then subjected to a hydrophilization treatment, which introduces a hydrophilic group to that surface, adding a hydrophilic nature to the PE coated layer. Since reactivity of polyethylene is higher than that of polypropylene, the hydrophilization treatment may have a higher efficiency, thus improving the hydrophilic nature.

The hydrophilization treatment includes a sulfonation treatment and a radical reaction treatment, such as a corona discharge treatment, a plasma treatment, a UV treatment, or ozonization, etc. Note that the sulfonation treatment may be based on any one of well-known treatments, such as a treatment using hot concentrated sulfuric acid, fuming sulfuric acid, or SO₃ gas.

Furthermore, in step S2 of this embodiment, since the polyethylene resin coated layer is formed uniformly on the entire surface of the base fabric, damage to the base fabric due to sulfonation may be prevented effectively, and decrease in the mechanical strength of the separator due to the sulfonation treatment may also be suppressed.

Moreover, such a hydrophilization treatment can be combined with another treatment. For example, first, a corona discharge treatment may be carried out, and then a sulfonation treatment may be carried out. In this case, since the PE coated layer, which has become hydrophilic through introduction of a carboxylic acid group beforehand, is subjected to a sulfonation treatment, the efficiency of the treatment is further improved and a much better hydrophilic nature is provided.

That is, the hydrophilic nature of the dry-type polypropylene nonwoven fabric may be improved using the aforementioned method, allowing provision of a battery separator having a greater mechanical strength and an improved hydrophilic nature compatible therewith.

The separator may be manufactured through these steps. When manufacturing only the separator but not a battery, the subsequent steps are unnecessary when fabrication of the separator has been completed through the steps described above.

Manufacturing steps for a secondary battery using this separator is described hereafter. Usually, since the separator and the secondary battery are manufactured at different sites, the separator fabricated in steps S1 to S3 is sent to a battery manufacturing site, and is then cut into a specific form according to the specification of the battery, in step S4. In step S5, a positive and a negative electrode material (electrode plates), and a separator are laid, rolled, and then stored in a battery case (battery can). Note that an alternately laminated structure of a positive and a negative electrode material (electrode plates), and a separator may be used alternatively, and any type of laminated structures can be used as long as they conform to the specification of the battery.

In step S6, the positive and the negative electrode plates are connected to a positive and a negative electrode of the battery case, respectively, by welding etc. In step S7, an electrolytic solution is injected into the battery case. In step S8, an inlet of the battery case is then sealed with a battery case lid etc., completing the formation of the battery.

Note that the secondary battery manufacturing method is not limited to the above-described examples, and is not limited to any detailed specifications as long as it is a battery using the separator according to this embodiment.

Next, working examples of a battery separator according to the present invention are described using comparative examples.

### WORKING EXAMPLE 1]

A polyethylene (hereafter, referred to as PE) emulsion solution (e.g., “CHEMIPEARL M200” made by Mitsui Chemicals, Inc. is available. CHEMIPEARL is a registered trademark of Mitsui Chemicals, Inc.) is applied to a spunbonded nonwoven fabric made of polypropylene (hereafter, referred to as PP) 53 g/m² in fabric weight and 125 μm in thickness using a dip method so that the coating rate is 0.1 wt %, and the resulting fabric is dried at 125° C. and fixed, and then subjected to PE coating. Afterwards, the resulting fabric is subjected to a corona discharge treatment with a treatment density of 220 kW/m²/min so as to be hydrophilic, resulting in a completed battery separator.

### WORKING EXAMPLE 2]

A battery separator is fabricated in the same manner as in working example 1 except that the coating rate of the PE emulsion solution is changed to 1 wt %.

### WORKING EXAMPLE 3]

A battery separator is fabricated in the same manner as in working example 1 except that the coating rate of the PE emulsion solution is changed to 3 wt %.

### WORKING EXAMPLE 4]

A battery separator is fabricated in the same manner as in working example 1 except that the coating rate of the PE emulsion solution is changed to 5 wt %.

### WORKING EXAMPLE 5]

A battery separator is fabricated in the same manner as in working example 1 except that the coating rate of the PE emulsion solution is changed to 10 wt %.

### WORKING EXAMPLE 6]

A battery separator is fabricated in the same manner as in working example 1 except that “MEIKATEX HP-70” (made by Meisei Chemical Works, Ltd.) is used alternatively as the PE emulsion solution and that the coating rate of the PE emulsion solution is changed to 3 wt %.

### WORKING EXAMPLE 7]

A battery separator is fabricated in the same manner as in working example 1 except that UV ozonization is carried out for 3 minutes under conditions of an ozone concentration of approximately 300 ppm and ultraviolet illuminance of approximately 15 mV/cm² instead of using the corona discharge treatment so as for it to have hydrophilicity and that the coating rate of the PE emulsion solution is changed to 3 wt %.

### WORKING EXAMPLE 8]

A PE emulsion solution (“CHEMIPEARL M200” made by Mitsui Chemicals, Inc.) is applied to a spunbonded nonwoven fabric made of PP, 53 g/m² in fabric weight and 125 μm in thickness using a dip method so that the coating rate is 3 wt %, and the resulting fabric is dried at 125° C. and fixed, and then subjected to PE coating. Afterwards, a sulfonation treatment is carried out by making the resulting fabric react to a nitrogen gas containing a 10 mol % SO₃ gas for 2 minutes at 25° C., and the resulting fabric is then immersed in a NaOH aqueous solution of approximately 10 wt % for 5 minutes, washed, and dried at 70° C., resulting in a completed sulfonated separator for batteries.

### WORKING EXAMPLE 9]

A sulfonated separator for batteries is fabricated in the same manner as in working example 8 except that the fabric is subjected to a corona discharge treatment with a treatment density of 220 kW/m²/min before the sulfonation treatment.

### COMPARATIVE EXAMPLE 1]

A spunbonded nonwoven fabric made of PP, 53 g/m² in fabric weight and 125 μm in thickness is subjected to a corona discharge treatment with a treatment density of 220 kW/m²/min, resulting in a completed battery separator.

### COMPARATIVE EXAMPLE 2]

An unwoven fabric, 53 g/m² in fabric weight and 125 μm in thickness is made from a sheath-core type fiber made of PP and PE, 11 μm in fiber diameter and 5 mm in fiber length. It is then subjected to the corona discharge treatment with the treatment density of 220 kW/m²/min, resulting in a completed separator for batteries.

### COMPARATIVE EXAMPLE 3]

A battery separator is fabricated in the same manner as in working example 1 except that the coating rate of the PE emulsion solution is changed to 20 wt %.

### COMPARATIVE EXAMPLE 4]

A battery separator is fabricated in the same manner as in comparative example 1 except that a sulfonation treatment is carried out instead of the corona discharge treatment by making the fabric react to a nitrogen gas containing a 10 mol % SO₃ gas for 2 minutes at 25° C.

### COMPARATIVE EXAMPLE 5]

A battery separator is fabricated in the same manner as in comparative example 2 except that a sulfonation treatment is carried out instead of the corona discharge treatment by making the fabric react to a nitrogen gas containing a 10 mol % SO₃ gas for 2 minutes at 25° C.

### COMPARATIVE EXAMPLE 6]

A sulfonated separator for batteries is fabricated in the same manner as in comparative example 1 except that a sulfonation treatment is carried out after the corona discharge treatment by making the fabric react to a nitrogen gas containing a 10 mol % SO₃ gas for 2 minutes at 25° C.

### COMPARATIVE EXAMPLE 7]

A sulfonated separator for batteries is fabricated in the same manner as in comparative example 2 except that a sulfonation treatment is carried out after the corona discharge treatment by making the fabric react to a nitrogen gas containing a 10 mol % SO₃ gas for 2 minutes at 25° C.

In order to compare the strength of the separators fabricated in the aforementioned different processes, the following tension test is carried out. That is, tensile strength is measured using a thin strip shaped sample, 15 mm in width, which is gripped at an interval of 180 mm (grip distance) and given an elastic stress rate of 200 mm/min. Moreover, strength retention rate of the sulfonated separator before and after treatment is also calculated using the following equation (1) in order to investigate the degree of strength deterioration due to the sulfonation treatment.

Strength retention rate (%)={After-sulfonation strength (kgf)/Before-sulfonation strength (kgf)}×100 (1)

In order to compare hydrophilicity, a square separator, 30 mm×30 mm in size is floated on a 30 wt % KOH aqueous solution at 70° C., and an immersion liquid time or time until the separator gets wet thoroughly in an electrolytic solution is measured. The higher the hydrophilic nature, the shorter the time until it gets wet. This is because a high hydrophilic nature improves an affinity with the electrolytic solution.

Airtightness is measured in order to evaluate gas permeability of the separator. The airtightness is measured based on time (sec/100 cc) until 100 cc of air passes a point with a diameter of 6 mm on a separator paper, which is pressed down and held on a lower part test piece attaching portion of a B type measuring instrument furnished with an adapter with a diameter of 6 mm according to JIS P8117 (Method of determining air permeance and air resistance of paper and board).

Table 1 shows a list of the measurement results. Table 1 is a table describing tensile strength, immersion liquid time, and airtightness.

TABLE 1

| | Tensile | Strength | Immersion | |
|---|---|---|---|---|
| | strength | retention rate | liquid time | Airtightness |
| | (kgf/15 mm) | (%) | (sec) | (sec/100 cc) |
| Working | 3.82 | — | 90.3 | 4.4 |
| example 1 | | | | |
| Working | 3.95 | — | 43.2 | 4.5 |
| example 2 | | | | |
| Working | 4.05 | — | 24.1 | 5.2 |
| example 3 | | | | |
| Working | 4.09 | — | 12.3 | 8.3 |
| example 4 | | | | |
| Working | 4.22 | — | 10.2 | 18.9 |
| example 5 | | | | |
| Working | 3.95 | — | 15.3 | 5.3 |
| example 6 | | | | |
| Working | 4.03 | — | 14.5 | 5.1 |
| example 7 | | | | |
| Working | 4.03 | 99.6 | 12.2 | 5.1 |
| example 8 | | | | |
| Working | 4.04 | 99.7 | 11.3 | 5.0 |
| example 9 | | | | |
| Comparative | 3.84 | — | 200.4 | 4.5 |
| example 1 | | | | |
| Comparative | 3.12 | — | 33.4 | 4.3 |
| example 2 | | | | |
| Comparative | 4.43 | — | 35.2 | 63.9 |
| example 3 | | | | |
| Comparative | 3.23 | 86.2 | 162.3 | 4.4 |
| example 4 | | | | |
| Comparative | 2.31 | 79.5 | 15.3 | 4.5 |
| example 5 | | | | |
| Comparative | 3.46 | 90.2 | 152.6 | 4.3 |
| example 6 | | | | |
| Comparative | 2.61 | 83.6 | 11.8 | 4.6 |
| example 7 | | | | |

Table 1 shows that the separators of the spunbonded nonwoven fabric made of PP have a higher tensile strength than that of the separators of the wet-type nonwoven fabric in comparative examples 2, 5, and 7.

Meanwhile, it also shows that the separators PE-coated and subjected to the corona discharge treatment in working examples 1 to 5 even have a higher hydrophilic nature. This is because those separators have a higher reactive PE surface than PP and therefore have a shorter immersion liquid time than that of the uncoated, spunbonded nonwoven fabric made of PP in comparative example 1. The sample of working example 5 with a 10 wt % PE emulsion coating rate, in particular, appears to have a high hydrophilic nature exceeding that of the wet-type nonwoven fabric separator in comparative example 2.

However, when the coating rate of the PE emulsion is raised, the gap between fibers is filled with the PE emulsion, resulting in an increased airtightness. In particular, the separator of comparative example 3 with a 20 wt % PE emulsion coating rate cannot be used as a separator because the airtightness has increased rapidly.

Moreover, since capillarity does not work well, the immersion liquid time also begins to increase when the coating rate has exceeded 10 wt %. In light of the balance of the immersion liquid time and the airtightness, the sample of working example 3 with a 3 wt % coating rate is found to be preferable as a battery separator.

Also, the sample of working example 6 to which ester-modified PE emulsion “MEIKATEX HP-70” is applied instead of “CHEMIPEARL M200” is found having a higher hydrophilic nature than that of comparative example 1. Similarly, the sample of working example 7 subjected to the UV ozonization treatment instead of the corona treatment is also found having a higher hydrophilic nature than that of comparative example 1.

On the other hand, the sulfonated separators of working examples 8 and 9 are found having a higher strength retention rate before and after the sulfonation treatment than those not PE-coated in comparative examples 4 and 6. This is because the PE coated layer prevents deterioration of the nonwoven fabric due to the sulfonation treatment.

Even in hydrophilic nature, the separators of working examples 8 and 9 are found having higher values than those uncoated in comparative examples 4 and 6, because the separators of working examples 8 and 9 have a PE surface formed higher than PP as far as reactivity is concerned. In particular, the separator of working example 9 is found having a hydrophilic nature equivalent to the sulfonated separator made of the wet-type nonwoven fabric of comparative example 5. This is because the separator of working example 9 is subjected to the hydrophilization treatment before the sulfonation treatment, and its sulfonation treatment efficiency is improved.

Next, an encapsulated-type nickel-hydrogen battery is fabricated using the fabricated separator. As materials for the battery, a sintering-type nickel electrode is used as the positive electrode, a sintering-type hydrogen absorbing alloy (metal hydride) is used as the negative electrode, and a 30 wt % potassium hydroxide aqueous solution is used as the electrolytic solution. Note that the sample of comparative example 3 is excluded because its airtightness is high and thus clearly unsuitable as a battery separator.

The fabricated, encapsulated-type nickel-hydrogen battery is initially activated by being charged and discharged alternately and repeatedly for ten cycles under conditions of a 0.1 C charge rate for 12 hours, a pause for 0.5 hours, a 0.1 C discharge rate, and a final voltage of 1.0 V.

### [Percent Defective]

100 batteries using each separator are fabricated through the above-described treatments, and the percent defective thereof is investigated.

### [Self-Discharge Test]

The initially activated, closed-type nickel-hydrogen battery is subjected to 5 repeated activation cycles, each including charging at a 0.1 C charge rate for 12 hours, pausing for 0.5 hours, and discharging at a 0.1 C discharge rate until a final voltage of 1.0V is reached. Ratio, to the resulting discharge capacity, of the state of charge (remaining capacity at a 0.1 C discharge rate and final voltage of 1.0 V) resulting from charging the battery under the same condition (0.1 C charge rate) and then leaving it as is for 14 days at 45° C. is defined as a capacity preservation rate after self-discharge. Note that all charging and discharging are performed at 25° C.

### [Cycle-Life Test]

The initially activated, closed-type nickel-hydrogen battery is subjected to a repetitive activation cycles each including charging at a 1.0 C charge rate for 1.1 hours at 25° C., pausing for 1.0 hour, and discharging at a 1.0 C discharge rate until the final voltage of 1.0V is reached, so that the number of the cycles when the utilization rate relative to the theoretical capacity becomes 80% or less is measured as a cycle life.

Battery test results of the secondary batteries using the above-described separator are shown in Table 2.

TABLE 2

| | | Capacity | |
|---|---|---|---|
| | Percent | preservation | Cycle |
| | defective | rate | life |
| Working | 0 | 51 | 553 |
| example 1 | | | |
| Working | 0 | 50 | 583 |
| example 2 | | | |
| Working | 0 | 52 | 601 |
| example 3 | | | |
| Working | 0 | 50 | 628 |
| example 4 | | | |
| Working | 0 | 51 | 650 |
| example 5 | | | |
| Working | 0 | 53 | 591 |
| example 6 | | | |
| Working | 0 | 55 | 593 |
| example 7 | | | |
| Working | 0 | 85 | 724 |
| example 8 | | | |
| Working | 0 | 86 | 753 |
| example 9 | | | |
| Comparative | 0 | 50 | 350 |
| example 1 | | | |
| Comparative | 1 | 52 | 642 |
| example 2 | | | |
| Comparative | — | — | — |
| example 3 | | | |
| Comparative | 1 | 79 | 504 |
| example 4 | | | |
| Comparative | 3 | 85 | 712 |
| example 5 | | | |
| Comparative | 0 | 77 | 557 |
| example 6 | | | |
| Comparative | 2 | 83 | 751 |
| example 7 | | | |

Percent defective of comparative examples 2 and 4 is 1%, that of comparative example 5 is 2%, that of comparative example 7 is 3%, and that of the others are 0%. Causes of the defectives are a short circuit caused by a broken separator due to a burr of an electrode, and a short circuit caused by contacted positive and negative electrodes resulting from contraction of the separator's width due to a tensile force exerted at the time of battery fabrication.

The capacitance retention rate of the sulfonated separators is found higher than that of separators subjected to the other hydrophilization treatments. However, less difference is found among the separators subjected to the same treatment.

On the other hand, the cycle life of the batteries using the PE-coated separator is found longer than that of batteries using the uncoated separator. This is considered to be because the PE coating improves the hydrophilic nature and improves an affinity with the electrolytic solution accordingly, resulting in prevention of the electrolytic solution from drying up. The separator in working example 9 particularly is found having a cycle characteristic equivalent to the separator made of the wet-type nonwoven fabric in comparative example 7 subjected to the corona treatment and the sulfonation treatment.

As described above, according to the working examples, the spunbonded nonwoven fabric made of PP on the surface of which the PE coated layer is formed is subjected to a sulfonation treatment and/or a radical reaction treatment, such as a corona discharge treatment, a plasma treatment, or UV ozonization, independently or as a combination thereof. This allows provision of a battery separator and a battery having a high mechanical strength along with a high hydrophilic nature.

As many apparently widely different embodiments of the present invention can be made without departing from the spirit and scope thereof, it is to be understood that the invention is not limited to the specific embodiments thereof except as defined in the appended claims.

What is claimed is:

1. A method of forming a battery separator to be sandwiched between a positive and a negative electrode of a battery, wherein said method comprises the steps of: forming a polyethylene resin coated layer on a surface of a nonwoven fabric made of polypropylene resin as a main component material and which is structured with bonded pieces of the polypropylene resin, and subjecting the polyethylene resin surface to a hydrophilization treatment.

2. The method of forming a battery separator according to claim 1, wherein said subjecting the polyethylene resin surface to a hydrophilization treatment includes at least one of a radical reaction treatment and a sulfonation treatment.

3. The method of forming a battery separator according to claim 2, wherein said subjecting the polyethylene resin surface to a hydrophilization treatment is carried out by carrying out a radical reaction treatment followed by a sulfonation treatment.

4. The method of forming a battery separator according to claim 3, wherein the radical reaction treatment is a treatment selected from a corona discharge treatment, a plasma treatment, and UV ozonization.

5. The method of forming a battery separator according to claim 4, wherein said step of forming the polyethylene resin coated layer on the surface of the nonwoven fabric is carried out by applying a polyethylene emulsion to the surface of the nonwoven fabric.

6. The method of forming a battery separator according to claim 5, wherein a coating weight of the polyethylene emulsion is 0.1 wt % to 10.0 wt % relative to a basic weight of the nonwoven fabric.

7. The method of forming a battery separator according to claim 6, wherein the nonwoven fabric is fabricated using spunbond technology.
